(19) United States
(12) Patent Application Publication
(10) Pub. No.: US 2026/0037150 A1
(43) Pub. Date: Feb. 5, 2026

(54) STORAGE SYSTEM AND OPERATING METHOD THEREOF

(71) Applicant: SK hynix Inc., Gyeonggi-do (KR)

(72) Inventor: In Jong JANG, Gyeonggi-do (KR)

(21) Appl. No.: 19/215,337

(22) Filed: May 22, 2025

(30) Foreign Application Priority Data
Aug. 1, 2024 (KR) 10-2024-0102601

(51) Int. Cl. G06F 3/06

(52) U.S. Cl. CPC G06F 3/0619; G06F 3/0656; G06F 3/0659; G06F 3/0673

(57) ABSTRACT

A storage device may comprise a data buffer, a linear search engine, and a device controller. The data buffer may store data to be received from or transmitted to a host. The linear search engine may store a plurality of entries access-requested by the host. The device controller may provide the host with a read fail response when it is determined that a read operation on data stored in a memory block fails, and search for recovery data to substitute the data stored at a read fail address of the memory block from at least one of the data buffer and the linear search engine in response to a recovery data search command received from the host.

### CROSS-REFERENCE TO RELATED APPLICATION

The present application claims priority under 35 U.S.C. § 119(a) to Korean patent application number 10-2024-0102601 filed on Aug. 1, 2024, the entire disclosure of which is incorporated by reference herein.

### BACKGROUND

### 1. Technical Field

The embodiments of the present disclosure generally relate to an electronic device, and more particularly, to a storage system and an operating method thereof.

### 2. Related Art

A storage system may include a host, such as a computer or a smartphone, and a storage device which stores data under the control of the host. The storage device may include a memory device in which data is stored and a memory controller which controls the memory device. The memory device is classified into a volatile memory device and a nonvolatile memory device.

The storage device may store data received from the host in the memory device according to a request of the host, or read data stored in the memory device and provide the read data to the host. When an operation of reading data corresponding to an address, which is received from the host, fails, the storage device may perform various data search operations to recover read fail data stored at the address.

### SUMMARY

Embodiments of the present disclosure provide a storage device performing a search operation of recovery data to substitute for read fail data, and an operating method of the storage device.

In accordance with an embodiment of the present disclosure, there is provided a storage system including a storage device and a host controlling the storage device. The storage device is configured to provide the host with a read fail address and a read fail response when it is determined that a read operation on data stored at the read fail address in a memory block fails. The host is configured to perform at least one of searching for, in the host, recovery data to substitute for the data stored at the read fail address and providing the storage device with a recovery data search command for requesting searching of the recovery data, in response to the read fail response.

In accordance with another embodiment of the present disclosure, there is provided a method of operating a storage system including a storage device and a host controlling the storage device. The method includes providing, by the storage device, the host with a read fail address and a read fail response when it is determined that a read operation on data stored at the read fail address in a memory device fails; and searching for, by the host, in the host, recovery data to substitute for the data stored the read fail address or providing the storage device with a recovery data search command for requesting searching of the recovery data, in response to the read fail response.

### BRIEF DESCRIPTION OF THE DRAWINGS

Various embodiments of the present disclosure will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a storage system in accordance with an embodiment of the present disclosure.

FIG. 2 is a diagram illustrating a log storage shown in FIG. 1.

FIG. 3 is a diagram illustrating a data buffer shown in FIG. 1.

FIG. 4 is a diagram illustrating a linear search engine shown in FIG. 1.

FIG. 5 is a diagram illustrating a logical block address history table shown in FIG. 1.

FIG. 6 is a diagram illustrating a logical-to-physical mapping table shown in FIG. 1.

FIG. 7 is a diagram illustrating a rewrite operation of recovery data in accordance with an embodiment of the present disclosure.

FIG. 8 is a flowchart illustrating an operation of a host in accordance with an embodiment of the present disclosure.

FIG. 9 is a flowchart illustrating an operation of a storage device in accordance with an embodiment of the present disclosure.

FIG. 10A is a flowchart illustrating an operation of the storage device in accordance with an embodiment of the present disclosure.

FIG. 10B is a flowchart illustrating an operation of the storage device in accordance with an embodiment of the present disclosure.

FIG. 11 is a flowchart illustrating an operation of the storage device in accordance with an embodiment of the present disclosure.

FIG. 12 is a diagram illustrating a sense key in accordance with an embodiment of the present disclosure.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and cannot be construed as limited to the embodiments set forth herein.

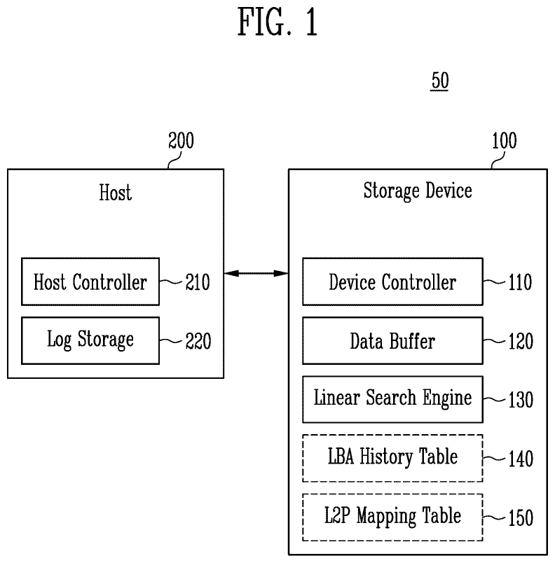

FIG. 1 is a diagram illustrating a storage system 50 in accordance with an embodiment of the present disclosure.

Referring to FIG. 1, the storage system 50 may include a storage device 100 and a host 200 which controls an operation of the storage device 100.

The storage device 100 may store data. The storage device 100 may operate under the control of the host 200. The storage device 100 may include one or more memory blocks which store data.

The storage device 100 may receive a request and an address from the host 200, and access an area of a memory block selected by the address. That is, the storage device 100 may perform an operation indicated by the request on the area selected by the address. For example, the storage device 100 may perform a write operation (program operation), a read operation, and an erase operation. In the program operation, the storage device 100 may program data in the area selected by the address. In the read operation, the storage device 100 may read data from the area selected by the address. In the erase operation, the storage device 100 may erase data stored in the area selected by the address.

The host 200 may control the storage device 100 to perform a program operation, a read operation, an erase operation, or the like. In the program operation, the host 200 may provide a write request, a logical block address, and data to the storage device 100. In the read operation, the host 200 may provide a read request and a logical block address to the storage device 100. In an embodiment, the storage device 100 may autonomously generate a command, an address, and data, regardless of any request from the host 200, and perform a program, read or erase operation based on the generated command, address, and data.

In an embodiment, the storage device 100 may include a device controller 110, a data buffer 120, and a linear search engine 130.

The device controller 110 may provide, to the host 200, a read fail address and a read fail response when a read operation on data stored in the memory block fails. The read fail response may include a sense key indicating a cause code of the fail of the read operation.

The device controller 110 may search for recovery data in the storage device 100 in response to a recovery data search command. The recovery data may be data to substitute for original data stored at the read fail address.

The device controller 110 may provide, to the host 200, the recovery data and a recovery data search pass response, or a recovery data search fail response according to whether the recovery data has been detected (found).

The device controller 110 may search for the recovery data in the data buffer 120, using the read fail address. When the recovery data is detected, the device controller 110 may provide, to the host 200, the recovery data and the recovery data search pass response.

The device controller 110 may detect a target entry including the read fail address, among a plurality of entries through the linear search engine 130. The device controller 110 may detect, as the recovery data, data generated using data patterns corresponding to the target entry.

The device controller 110 may search for the recovery data through the linear search engine 130 when the recovery data is not detected in the data buffer 120. The device controller 110 may provide, to the host 200, the recovery data search fail response when the recovery data is not detected by the linear search engine 130. In some embodiments, the device controller 110 may search for the recovery data through another search engine other than the linear search engine 130 when the recovery data is not detected by the linear search engine 130. The other search engine may infer the original data, using patterns of data having a history in which the patterns have corresponded to the read fail address in a logical block address (LBA) history table 140. The device controller 110 may detect the inferred original data as the recovery data.

The data buffer 120 may store data to be received from or transmitted to the host 200.

The linear search engine 130 may store a plurality of entries. Each entry may include a start address of a sequential address access-requested by the host 200, a length of the sequential address, and data patterns extracted from data stored at the sequential address.

In an embodiment, the storage device 100 may further include the LBA history table 140. The storage device 100 may further include a logical-to-physical (L2P) mapping table 150.

The LBA history table 140 may include physical block addresses having a history in which the physical block addresses have been mapped to the read fail address. The L2P mapping table 150 may include mapping information between a logical block address and a physical block address.

The device controller 110 may detect, as the recovery data, data stored at a physical block address previously mapped to the read fail address as compared with a physical address currently mapped to the read fail address in the LBA history table 140.

The device controller 110 may detect, as the recovery data, data predicted based on data stored at sequential addresses in a predetermined range, which include the read fail address, in the L2P mapping table 150.

The device controller 110 may write, to another memory block, remaining data except the read-failed original data among the data stored in the memory block, and the recovery data to substitute for the original data, in response to a rewrite command received from the host 200. The device controller 110 may process, as a bad block, the memory block after the writing to the other memory block.

The host 200 may include a host controller 210 and a log storage 220.

When the host controller 210 receives a read fail response from the storage device 100, the host controller 210 may search for recovery data to substitute for the original data stored at the read fail address in the host 200. In some embodiments, when the host controller 210 receives the read fail response, the host controller 210 may provide the storage device 100 with a recovery data search command for requesting searching of recovery data.

For example, when a priority order of a read operation is urgent, the host controller 210 may search for recovery data in the host 200 or provide the recovery data search command to the storage device 100. When the priority order of the read operation is not urgent, the host controller 210 may provide a fail response of the read operation to a user. The host controller 210 may provide the recovery data search command to the storage device 100 after the storage device 100 enters into an idle state.

The host controller 210 may search for recovery data in the log storage 220, using a read fail address. The host controller 210 may provide a pass response of the read operation to the user when the recovery data is detected in the log storage 220 or when the recovery data is received from the storage device 100. After that, the host controller 210 may provide a rewrite command of the recovery data to the storage device 100.

The log storage 220 may store log information including an access request for the storage device 100 and data according to the access request.

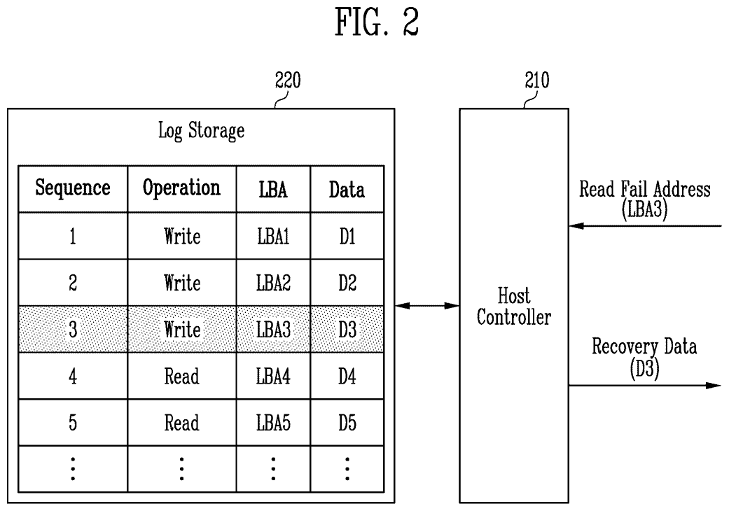

FIG. 2 is a diagram illustrating the log storage 220 shown in FIG. 1.

Referring to FIG. 2, the log storage 220 may store log information including an access request for the storage device 100 and data according to the access request. For example, the log information may include a request for sequentially writing data D1, D2, and D3 at logical block addresses LBA1, LBA2, and LBA3. The log information may include a request for sequentially reading data D4 and D5 stored at logical block addresses LBA4 and LBA5.

The host controller 210 may search for recovery data in the log storage 220, using a read fail address. The host controller 210 may detect, as the recovery data, data D3 corresponding to a logical block address LBA3 as the read fail address in the log information.

In some embodiments, the host controller 210 may search for a space in which data is temporarily stored for the purpose of a write operation or a read operation, such as a host performance booster (HPB) buffer, in addition to the log storage 220. When data corresponding to the read fail address is searched in the corresponding space, the host controller 210 may detect the searched data as the recovery data.

In the embodiment described with reference to FIG. 2, the host 200 performs recovery data searching in not only the storage device 100 but also the host 200 itself, so that a recovery data search pass probability can be increased.

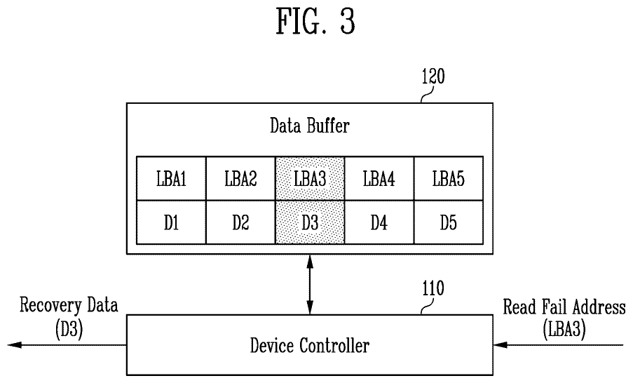

FIG. 3 is a diagram illustrating the data buffer 120 shown in FIG. 1.

Referring to FIG. 3, the data buffer 120 may store data to be received from or transmitted to the host 200. For example, the data buffer 120 may store data D1 to D5 respectively corresponding to logical block addresses LBA1 to LBA5, which are received from the host 200.

The device controller 110 may search for recovery data in the data buffer 120, using a read fail address. For example, the device controller 110 may detect, as the recovery data, data D3 corresponding to a logical block address LBA3 among the data D1 to D5 stored in the data buffer 120.

In the embodiment described with reference to FIG. 3, when data received from the host 200 is still not erased from the data buffer 120 even though the data has been completely written to the storage device 100, data in which an error occurs can be recovered using the data stored in the data buffer 120.

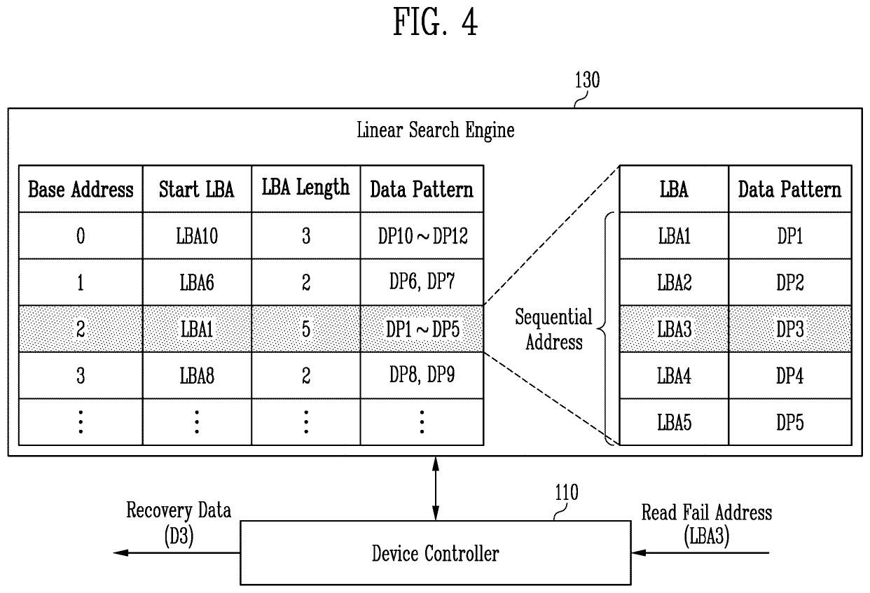

FIG. 4 is a diagram illustrating the linear search engine 130 shown in FIG. 1.

Referring to FIG. 4, the linear search engine 130 may store a plurality of entries. Each entry may include a start address of a sequential address access-requested by the host 200, a length of the sequential address, and data patterns extracted from data stored at the sequential address.

In FIG. 4, a base address may indicate an address at which each entry is stored. Data patterns DP1 to DP12 may be data extracted from data stored at corresponding logical block addresses LBA1 to LBA12. For example, a data pattern DP1 may be extracted from data D1 stored at a logical block address LBA1. Through an extraction process such as compression, the data pattern DP1 may be managed with a capacity less than a capacity of the data D1, and be used to recover the data D1.

The device controller 110 may detect a target entry including a read fail address among the plurality of entries through the linear search engine 130. The device controller 110 may detect, as recovery data, data generated using data patterns corresponding to the target entry.

For example, an entry in which the base address is 2 may include sequential addresses LBA1 to LBA5. Since the sequential addresses LBA1 to LBA5 include a logical block address LBA3 as the read fail address, the entry in which the base address is 2 may be the target entry. Therefore, the device controller 110 may generate data D3, using data patterns DP1 to DP5 corresponding to the target entry, and detect the data D3 as the recovery data.

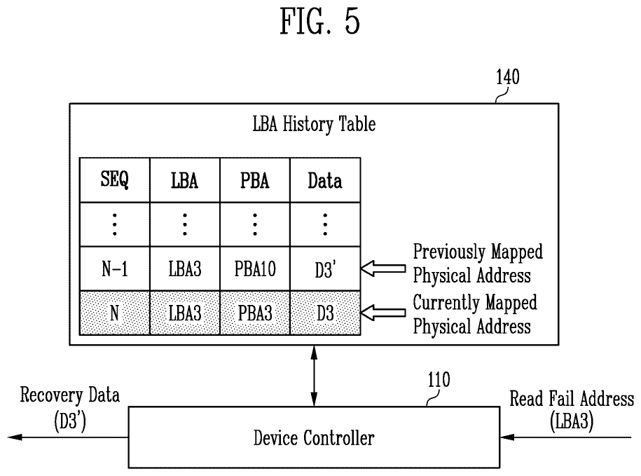

In the embodiment described with reference to FIG. 4, since data stored at sequential addresses are data sequentially accessed by the host 200 and are associated with each other, it is easy to recover error data, using remaining data even when an error occurs in some data. In addition, a data pattern is used instead of original data when error data is recovered, so that the original data can be easily recovered since the data pattern is normal (i.e., no error) even when an error occurs in the original data. FIG. 5 is a diagram illustrating the LBA history table 140 shown in FIG. 1.

Referring to FIG. 5, the LBA history table 140 may include physical block addresses having a history in which physical block addresses have been mapped to a read fail address.

For example, the LBA history table 140 may include a physical block address PBA3 currently mapped to a logical block address LBA3 as the read fail address and a physical block address PBA10 previously mapped to the logical block address LBA3 as the read fail address.

Data D3 stored at the physical block address PBA3 mapped to the logical block address LBA3 as the read fail address is not normally read. Therefore, the device controller 110 may detect, as recovery data, data D3′ stored at the physical block address PBA10 previously mapped to the logical block address LBA3 as the read fail address.

In the embodiment described with reference FIG. 5, when the mapping of the logical block address LBA3 is changed from the physical block address PBA10 to the physical block address PBA3 due to data movement instead of data renewal, the data D3′ can be used as the recovery data since the data D3′ is identical to the data D3.

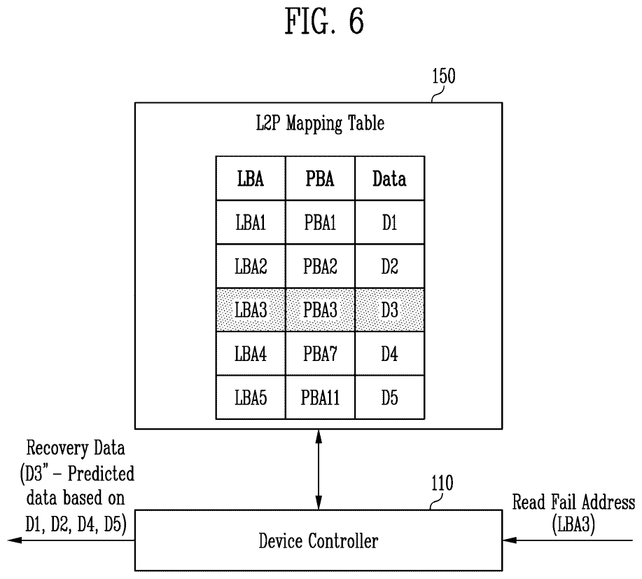

FIG. 6 is a diagram illustrating the L2P mapping table 150 shown in FIG. 1.

Referring to FIG. 6, the L2P mapping table 150 may include mapping information between a logical block address LBA and a physical block address PBA.

For example, a logical block address LBA1 may be mapped to a physical block address PBA1. A logical block address LBA2 may be mapped to a physical block address PBA2. A logical block address LBA3 may be mapped to a physical block address PBA3. A logical block address LBA4 may be mapped to a physical block address PBA7. A logical block address LBA5 may be mapped to a physical block address PBA11. Data D1, D2, D3, D4, and D5 may be stored at corresponding physical block addresses PBA1, PBA2, PBA3, PBA7, and PBA11, respectively.

The device controller 110 described with reference to FIG. 1 may detect, as recovery data, data predicted based on data stored at sequential addresses in a predetermined range, which include a read fail address, in the L2P mapping table 150.

For example, the sequential addresses in the predetermined range may be logical block addresses LBA1 to LBA5 having a sequence from −2 to +2 with respect to the logical block address LBA3 as the read fail address. The predetermined range is not limited to this embodiment.

A read operation may not be normally performed on data D3 stored at the physical block address PBA3 mapped to the logical block address LBA3 as the read fail address. Therefore, data D3″ to be substitute for the data D3 may be predicted based on data D1, D2, D4, and D5 stored at physical block addresses PBA1, PBA2, PBA7, and PBA11 mapped to sequential logical block addresses LBA1, LBA2, LBA4, and LBA5 except the read fail address. The device controller 110 may detect the predicted data D3″ as the recovery data.

In the embodiment described with reference to FIG. 6, recovery data most adjacent to data stored at a read fail address can be generated using data stored at addresses adjacent to the read fail address.

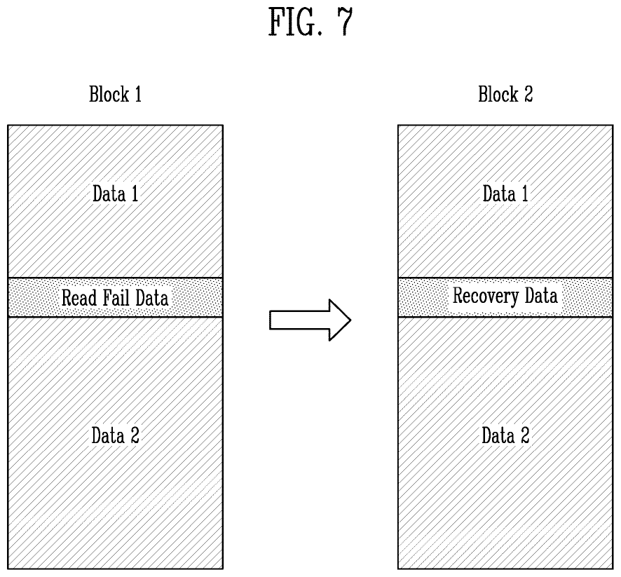

FIG. 7 is a diagram illustrating a rewrite operation of recovery data in accordance with an embodiment of the present disclosure.

Referring to FIG. 7, the storage device 100 may rewrite, to another second memory block Block 2, remaining data Data1 and Data2 of a first memory block Block 1 except data on which reading fails, and recovery data in response to a rewrite command received from the host 200. After the rewriting is completed, the first memory block Block 1 may be processed as a bad block.

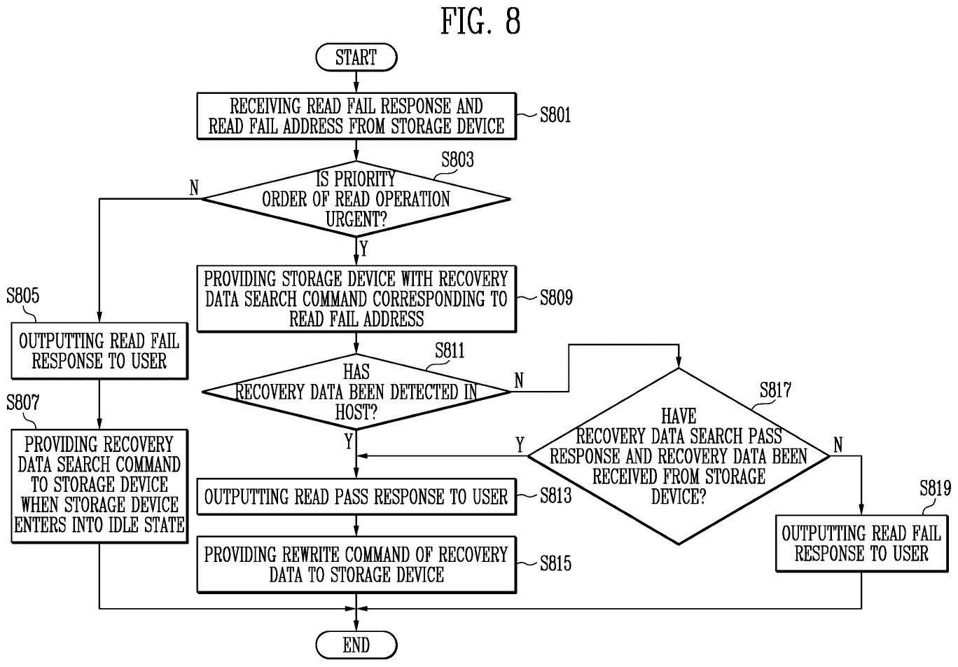

FIG. 8 is a flowchart illustrating an operation of a host (e.g., the host 200 of FIG. 1) in accordance with an embodiment of the present disclosure.

Referring to FIG. 8, in S801, the host may receive a read fail response and a read fail address from the storage device.

In S803, the host may determine whether a priority order of a read operation which fails is urgent. The host may proceed to S809 when it is determined that the priority order of the read operation is urgent (S803, Y). The host may proceed to S805 when it is determined that the priority order of the read operation is not urgent (S803, N).

In S805, the host may output the read fail response to a user.

In S807, the host may provide a recovery data search command to the storage device when the storage device enters into an idle state.

In S809, the host may provide the storage device with a recovery data search command corresponding to the read fail address. Recovery data may be data to substitute for original data stored at the read fail address.

In S811, the host may determine whether the recovery data has been detected in the log storage. The host may proceed to S813 when it is determined that the recovery data is detected (S811, Y). The host may proceed to S817 when it is determined that the recovery data is not detected (S811, N).

In this specification, the operation order of the flowchart does not limit the operation order of the host. For example, in other embodiments, the host may perform the S811 earlier than the S809, and perform the S809 when it is determined that the recovery data is not detected as the determination result and then proceed to the S817.

In S813, the host may output a read pass response to the user.

In S815, the host may provide a rewrite command of the recovery data to the storage device.

In S817, the host may determine whether a recovery data search pass response and the recovery data have been received from the storage device. The host may proceed to the S813 when it is determined that the recovery data search pass response and the recovery data are received (S817, Y). The host may proceed to S819 when it is determined that the recovery data search pass response and the recovery data are not received.

In S819, the host may output the read fail response to the user.

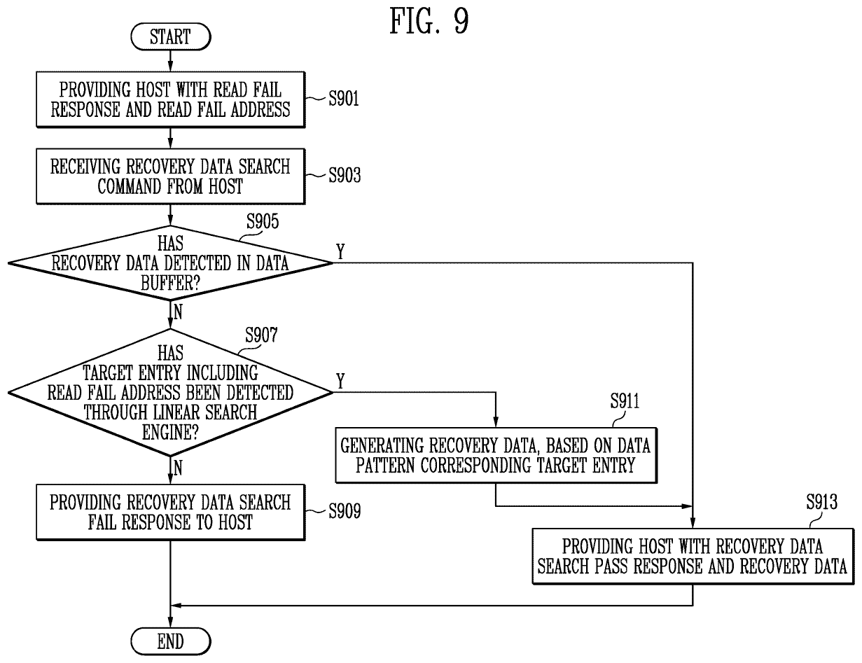

FIG. 9 is a flowchart illustrating an operation of a storage device (e.g., the storage device 100 of FIG. 1) in accordance with an embodiment of the present disclosure.

Referring to FIG. 9, in S901, the storage device may provide the host with a read fail response and a read fail address when a read operation fails.

In S903, the storage device may receive a recovery data search command from the host. The recovery data search command may be a command for requesting searching of recovery data to substitute for original data stored at the read fail address.

In S905, the storage device may determine whether recovery data has been detected in the data buffer. The storage device may proceed to S913 when it is determined that the recovery data is detected in the data buffer (S905, Y). The storage device may proceed to S907 when it is determined that the recovery data is not detected (S905, N).

In S907, the storage device may determine whether a target entry including the read fail address among a plurality of entries has been detected through the linear search engine. The storage device may proceed to S911 when it is determined that the target entry is detected (S907, Y). The storage device may proceed to S909 when it is determined that the target entry is not detected (S907, N).

In S909, the storage device may provide a recovery data search fail response to the host.

In S911, the storage device may generate recovery data, based on a data pattern corresponding to the target entry. Specifically, the storage device may detect, as the recovery data, data generated using data patterns extracted from data stored at sequential addresses which include the read fail address and are included in the target entry.

In S913, the storage device may provide the host with a recovery data search pass response and the recovery data.

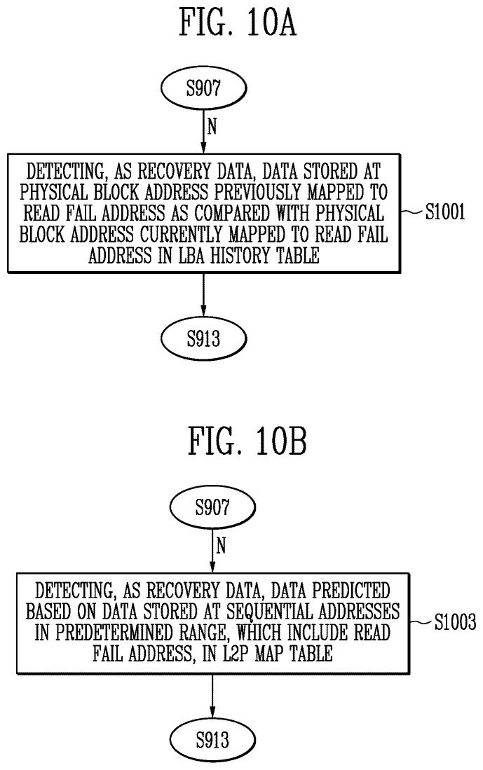

FIG. 10A is a flowchart illustrating an operation of the storage device in accordance with an embodiment of the present disclosure.

Referring to FIG. 10A, the storage device may proceed to S1001 instead of S909 when it is determined that the target entry including the read fail address is not detected through the linear search engine in S907 described with reference to FIG. 9 (i.e., S907, N).

In S1001, the storage device may detect, as the recovery data, data stored at a physical block address previously mapped to the read fail address as compared with a physical address currently mapped to the read fail address in the LBA history table.

After S1001, the storage device may proceed to S913 described with reference to FIG. 9.

FIG. 10B is a flowchart illustrating an operation of the storage device in accordance with an embodiment of the present disclosure.

Referring to FIG. 10B, the storage device may proceed to S1003 instead of S909 when it is determined that the target entry including the read fail address is not detected through the linear search engine in S907 described with reference to FIG. 9 (i.e., S907, N).

In S1003, the storage device may detect, as the recovery data, data predicted based on data stored at sequential addresses in a predetermined range, which include the read fail address, in the L2P map table.

After S1003, the storage device may proceed to the S913 described with reference to FIG. 9.

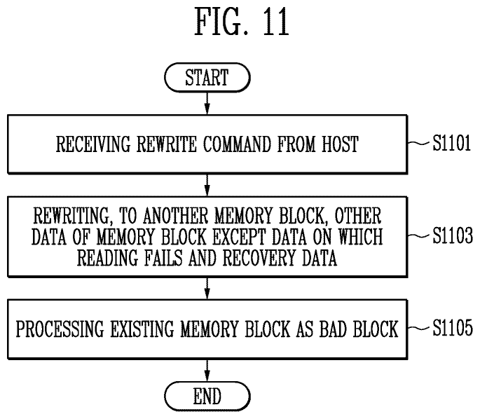

FIG. 11 is a flowchart illustrating an operation of the storage device in accordance with an embodiment of the present disclosure.

Referring to FIG. 11, in S1101, the storage device may receive a rewrite command from the host.

In S1103, the storage device may rewrite, to another memory block (e.g., a second memory block), remaining data of a memory block (e.g., a first memory block) except data on which reading fails, and recovery data.

In S1105, the storage device may process the existing memory block as a bad block.

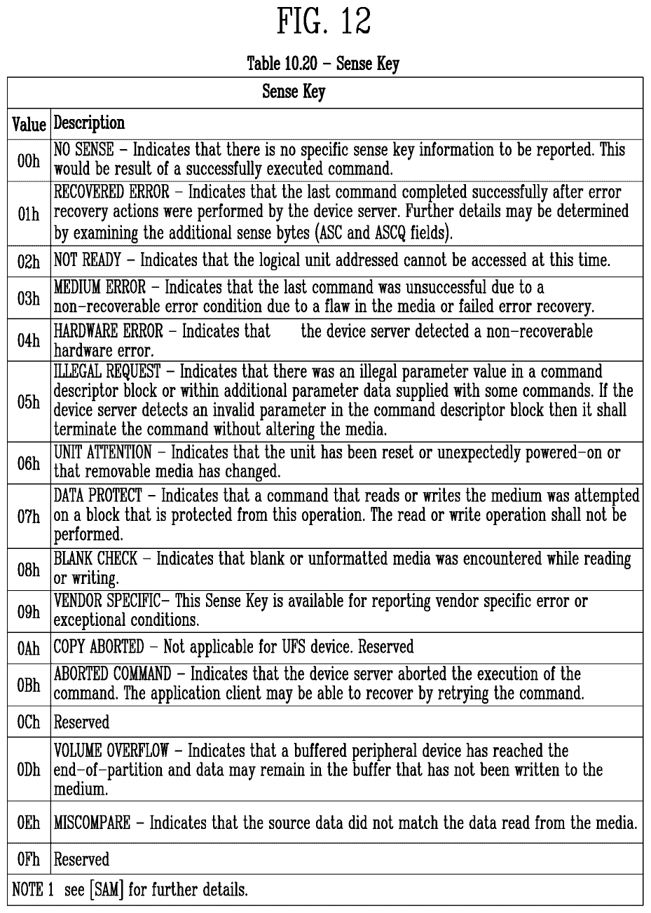

FIG. 12 is a diagram illustrating a sense key in accordance with an embodiment of the present disclosure.

Referring to FIGS. 1 and 12, when a read operation performed by the storage device 100 fails, the storage device 100 may provide the host 200 with a read fail response including a sense key and a read fail address. The read fail address may be provided to the host 200 while being separated from the sense key or be provided to the host 200 while being added to the sense key.

The sense key may indicate a cause code of the fail of the read operation. In an embodiment, when the cause code receives a MEDIUM ERROR as ‘03h’, a recovery data search operation may be performed.

In accordance with embodiments of the present disclosure, there is provided a storage device performing a search operation of recovery data to substitute for read fail data, and an operating method of the storage device.

While the embodiments of the present disclosure have been shown and described with reference to certain embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described embodiments but should be determined by not only the appended claims but also the equivalents thereof.

In the above-described embodiments, all operations may be selectively performed or part of the operations may be omitted. In each embodiment, the operations are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made based on the technological scope of the present disclosure.

The embodiments of the present disclosure have been described in the drawings and specification. Although specific terminologies are used here, those are only to describe the embodiments of the present disclosure. Therefore, the present disclosure is not restricted to the above-described embodiments and many variations are possible within the spirit and scope of the present disclosure. It should be apparent to those skilled in the art that various modifications can be made based on the technological scope of the present disclosure in addition to the embodiments disclosed herein. Furthermore, the embodiments may be combined to form additional embodiments.

What is claimed is:

1. A storage device comprising:
a data buffer configured to store data to be received from or transmitted to a host;
a linear search engine configured to store a plurality of entries access-requested by the host; and
a device controller configured to provide the host with a read fail response when it is determined that a read operation on data stored in a memory block fails, and to search for recovery data to substitute the data stored at a read fail address of the memory block from at least one of the data buffer and the linear search engine in response to a recovery data search command received from the host.

2. The storage device of claim 1, wherein the device controller receives the recovery data search command from the host after entering an idle state, based on whether a priority order of the read operation is urgent.

3. The storage device of claim 1, wherein the device controller, in response to a rewrite command received from the host, writes the recovery data and remaining data except the data stored at the read fail address in the memory block to another memory block, and processes the memory block as a bad block.

4. The storage device of claim 1, wherein the device controller searches for, as the recovery data, data corresponding to the read fail address in the data buffer.

5. The storage device of claim 1, wherein the device controller searches for the recovery data through the linear search engine when the recovery data is not detected in the data buffer.

6. The storage device of claim 1, wherein each of the plurality of entries includes a start address of a sequential address access-requested by the host, a length of the sequential address, and data patterns extracted from data stored at the sequential address.

7. The storage device of claim 6, wherein the device controller detects a target entry including the read fail address among the plurality of entries in the linear search engine, and detects, as the recovery data, data generated using data patterns corresponding to the target entry.

8. The storage device of claim 1, wherein the recovery data includes at least one of data inferred based on data with a history of being stored at the read fail address, and data with a history of being stored at a logical block address sequential to the read fail address.

9. The storage device of claim 1, wherein the storage device further comprises a logical block address history table including physical block addresses with a history of being mapped to the read fail address, and
wherein the device controller detects, as the recovery data, data stored at a physical block address previously mapped to the read fail address as compared with a physical block address currently mapped to the read fail address in the logical block address history table.

10. The storage device of claim 1, wherein the storage device further includes a logical-to-physical mapping table including mapping information between a logical block address and a physical block address, and
wherein the device controller detects, as the recovery data, data predicted based on data stored at sequential addresses in a predetermined range, which include the read fail address, in the logical-to-physical mapping table.

11. A method of operating a storage device, the method comprising:
providing a host with a read fail response when it is determined that a read operation on data stored in a memory block fails; and
searching for recovery data to substitute the data stored at a read fail address of the memory block from at least one of a data buffer and a linear search engine in response to a recovery data search command received from the host.

12. The method of claim 11, further comprising:
receiving the recovery data search command from the host after entering an idle state, based on whether a priority order of the read operation is urgent.

13. The method of claim 11, wherein searching for the recovery data includes:
searching for, as the recovery data, the data stored at the read fail address in the data buffer storing data to be received from or transmitted to the host; and
searching for the recovery data through the linear search engine when the recovery data is not detected in the data buffer.

14. The method of claim 13, wherein searching for the recovery data through the linear search engine includes:
detecting a target entry including the read fail address among a plurality of entries in the linear search engine; and
detecting, as the recovery data, data generated using data patterns corresponding to target entry.

15. The method of claim 14, wherein each of the plurality of entries includes a start address of a sequential address access-requested by the host, a length of the sequential address, and data patterns extracted from data stored at the sequential address.

16. The method of claim 11, further comprising:
writing to another memory block other than the memory block, remaining data except the data stored at the read fail address among data stored in the memory block, and the recovery data in response to a rewrite command received from a host; and
processing the memory block as a bad block.

17. A storage system comprising:
a host; and
a storage device controlled by the host, and configured to provide the host with a read fail address and a read fail response when it is determined that a read operation on data stored at the read fail address in a memory block fails,
wherein the host is configured to perform at least one of searching for, in the host, recovery data to substitute for the data stored at the read fail address and providing the storage device with a recovery data search command for requesting searching of the recovery data, in response to the read fail response.

18. The storage system of claim 17, wherein the host includes a host controller configured to:
search for the recovery data in the host or provide the recovery data search command to the storage device when it is determined that a priority order of the read operation is urgent,
output a fail response of the read operation when it is determined that the priority order of the read operation is not urgent, and
provide the recovery data search command to the storage device after the storage device enters into an idle state.

19. The storage system of claim 17, wherein the recovery data includes at least one of data inferred based on the data stored at the read fail address and data stored at a logical block address sequential to the read fail address.

20. The storage system of claim 17, wherein the host includes a log storage configured to store log information including an access request for the storage device and data according to the access request, and data access-requested to the read fail address in the log storage is searched as the recovery data.
